(19) United States
(12) Patent Application Publication
(10) Pub. No.: US 2025/0193210 A1
(43) Pub. Date: Jun. 12, 2025

(54) MALWARE EVOLUTION FOR PROACTIVE CYBER DEFENSE

(71) Applicants: Shayan Ahmed Khan; Usman Sikander; Osma Ellahi; Muhammad Haider Ali Khan; Muhammad Masoom Alam; Hammad Saleh Hadeed

(72) Inventors: Shayan Ahmed Khan; Usman Sikander; Osma Ellahi; Muhammad Haider Ali Khan; Muhammad Masoom Alam; Hammad Saleh Hadeed

(21) Appl. No.: 18/530,422

(22) Filed: Dec. 6, 2023

(51) Int. Cl. H04L 9/40

(52) U.S. Cl. CPC H04L 63/1408

(57) ABSTRACT

The invention provides an advanced security methodology, the Malware Evolution for Proactive Cyber Defense. The malware evolution assessment can assess one or more malware campaigns on single or multiple organization's assets to test the security architecture. It can automatically create multiple evolved malware campaigns of a base malware scenario to test all possible attack paths employed by different variants and potential future variants of same campaign. A campaign is a series of malware behaviors defining a cyber-attack execution path.

### BACKGROUND

The disclosed embodiments relate to malware modification and their threat assessment for cyber security.

In today's interconnected and digitized world, the significance of cyber security has surged to the forefront of global concerns. The frequency, sophistication, and relentless evolution of cyber-attacks have cast a shadow of uncertainty over organizations, governments, and individuals alike. The digital landscape now stands as a battleground where threats lurk around every virtual corner. From state-sponsored cyber espionage to ransomware attacks targeting critical infrastructure, the arsenal of cyber threats has never been more formidable. In this turbulent era, the imperative to fortify our digital defenses and safeguard sensitive data has never been more critical.

As cyber threats continue to evolve in complexity and scale, organizations must adopt a proactive and adaptive approach to defense. Simply fortifying digital perimeters with static security measures is no longer sufficient. Instead, there is an increasing need for organizations to harness the power of offensive security tactics, learning from the very malware and cyberattacks that seek to breach their defenses. By understanding the strategies employed by adversaries, organizations can develop a robust cybersecurity posture that not only anticipates but actively counters emerging threats. Simulating or emulating malware behaviors in an organization's premises provides very accurate security testing results by exposing all the weaknesses that are present in the security posture of an organization. By simulating or emulating malware behaviors on the network, the weakest link in its security architecture may be found.

The practice of emulating and simulating malware behaviors on computer systems is a pivotal and fundamental component of offensive security. This process entails the meticulous replication of the precise actions, tactics, and methodologies that malicious software, often colloquially referred to as “malware” employs to compromise the security of computer systems, networks, and data repositories. This replication, however, occurs within the confines of a controlled and secure environment that is either isolated from operational systems or executed in a very safe exploitation manner. The main goal of this emulation and simulation exercise is to carefully check how well an organization's security measures and response plans work, all while staying very alert to any possible problems or dangers. By subjecting simulated malware behaviors to scrutiny in this deliberate and systematic manner, cybersecurity practitioners may gain invaluable insights into the robustness, reliability, and adaptability of their defense strategies. In the context of today's rapidly evolving and increasingly sophisticated threat landscape, the capacity to systematically emulate and meticulously learn from malware behaviors emerges as a critical and indispensable mechanism for bolstering an organization's overall cybersecurity posture.

Simulating or emulating malware behavior by extracting Tactics, Techniques, and Procedures (TTPs) from real-world samples and recreating them in a safe exploitation manner is a sophisticated and proactive cybersecurity methodology aimed at understanding, defending against, and mitigating the threats posed by malicious software. The process begins with the collection and analysis of real-world malware samples. Security researchers or analysts dissect these samples to identify the specific TTPs employed by the malware. TTPs encompass the methods and tactics used by malware to compromise systems, establish control, and achieve its objectives. The TTP extraction process involves use of threat intel as well as Reverse Engineering malware sample to identify and extract TTPs, which are recreated into individual exploit behaviors that are executed in a sequence to simulate cyber-attack path, a generic methodology is provided in FIG. 1.

By simulating or emulating malware behavior while adhering to safe exploitation practices, organizations gain valuable insights into the tactics used by cyber adversaries. This proactive approach enables them to fortify their defenses, develop effective incident response plans, and enhance their overall cybersecurity posture in an ever-evolving threat landscape.

The above information disclosed in this background section is only for enhancement of understanding of the background of the inventive concept, and, therefore, it may contain information that does not form the prior art that is already known to a person of ordinary skill in the art.

### SUMMARY

A system comprising a computer server, configured to generate a plurality of combinations of TTPs; a testing module, configured to evaluate each combination of TTPs against a pre-defined threshold to determine their effectiveness; and a modification module, configured to adapt the TTP combinations based on the testing results until the predefined threshold is achieved.

The system is configured to execute a method comprising:
automatically creating malware variants by a method comprising taking, as input, a base scenario which is a known malware sample, along with a set of test cases or TTPs (Tactics, Techniques, and Procedures) that describe various aspects of the malware's behavior, wherein the test cases serve as reference points;
automatically modifying the malware by a method comprising identifying sub-techniques and procedures within the malware scenario or campaign; changing the sub-techniques or their procedures without changing the techniques to obtain the modified variants by keeping the core behavior of the malware unchanged; and, running the test cases against each variant to validate the existence of the core behavior of the malware. The method further comprises taking, as output, the modified variants, each representing a variation of the base scenario; and testing and comparing the risk associated with both, the base malware and the modified variant, against a pre-defined threshold of risk.

### BRIEF DESCRIPTION OF THE DRAWINGS

The accompanying drawings, which are included to provide a further understanding of the inventive concepts and are incorporated in and constitute a part of this specification, illustrate exemplary embodiments of the inventive concepts, and, together with the description, explain the principles of the inventive concepts.

FIG. 1 illustrates TTP extraction methodology. A real-world malware sample is Reverse Engineered and TTPs are extracted from it which are then recreated into safe exploitation test cases.

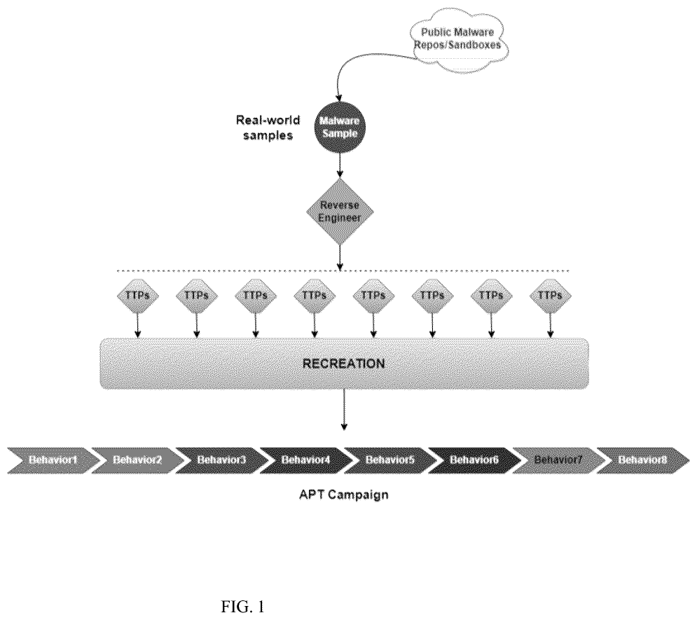

FIG. 2 illustrates the Malware modification methodology. A malware is modified based on the TTPs from MITRE ATT&CK framework in a way that Tactic and Techniques will always be same as the base scenario, but sub-techniques and procedures could be changed for modification.

FIG. 3 illustrates the modification on a specific behavior. An example of malware modification on process injection has been demonstrated in which the evolution methodology will select one of the listed sub-techniques or procedures.

FIG. 4 illustrates the evolution engine. A malware evolution engine is a software that takes as input a base malware scenario with sequence of TTPs and adds modifications to the sequence by changing sub-techniques or procedures, finally providing us the output as modified malware campaign.

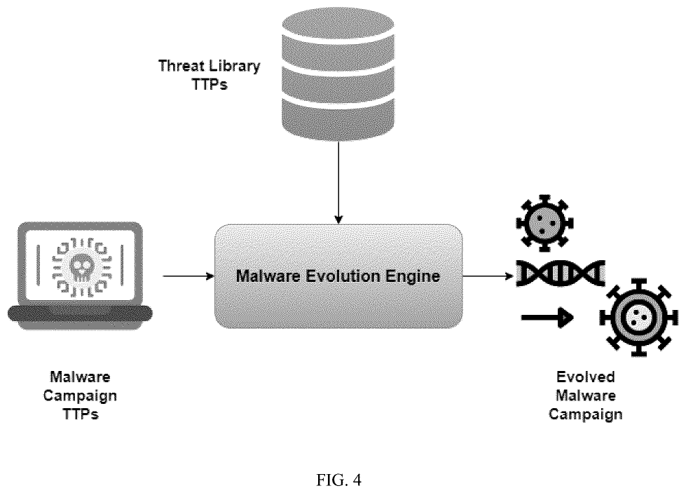

FIG. 5 illustrates the Malware Evolution Assessment. The modified campaigns are tested against security controls and evaluated based on risk score. If the score passed the defined threshold, then it would be termed as successful evolution.

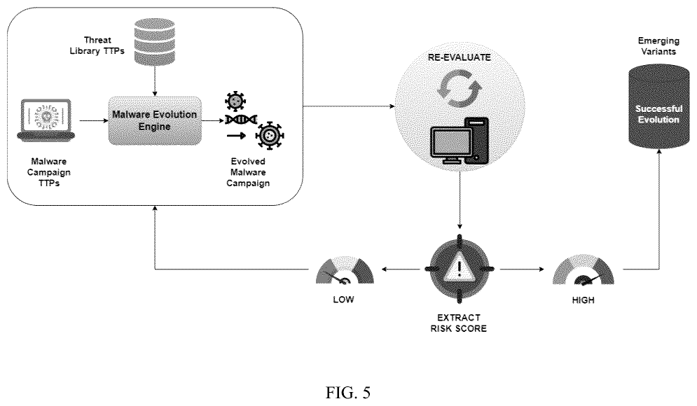

FIG. 6 illustrates the NanoCore Client v1.2.2.0 attack path. All TTPs of base malware scenario are provided which will be fed to Malware evolution engine.

FIG. 7 illustrates the NanoCore evolved campaign 1. This campaign has been created with deep inspection method by malware evolution engine.

FIG. 8 illustrates the NanoCore evolved campaign 2. This campaign has also been created with deep inspection method by malware evolution engine achieving better results.

FIG. 9 illustrates the NanoCore evolved campaign 3. This campaign has been created with attack survival method by malware evolution engine.

### DESCRIPTION OF THE INVENTION

In the following description, for the purposes of explanation, numerous specific details are set forth to provide a thorough understanding of various exemplary embodiments. It is apparent, however, that various exemplary embodiments may be practiced without these specific details or with one or more equivalent arrangements.

In the accompanying figures, the size and relative sizes of elements may be exaggerated for clarity and descriptive purposes. Also, like reference numerals denote like elements.

The terminology used herein is for the purpose of describing embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

The embodiments of the invention disclose a method of malware modification to create its variants and assess their relative potential of threat, the method hereinafter referred as malware evolution assessment. The method involves having a base campaign with all its TTPs extracted into individual behaviors or test cases and a threat library containing multiple TTPs extracted from multiple malware families. The malware behavior is altered in a way that it becomes more effective in evading defenses, and it is called as malware evolution assessment because the malware base scenario is constantly being changed into more sophisticated malware until an evolved malware scenario is obtained that achieves higher impact or risk ratio than the defined threshold.

An embodiment of the present invention discloses a system comprising a computer server, configured to generate a plurality of combinations of TTPs; a testing module, configured to evaluate each combination of TTPs against a pre-defined threshold to determine their effectiveness; and a modification module, configured to adapt the TTP combinations based on the testing results until the predefined threshold is achieved.

The system is configured to execute a method comprising:
automatically creating malware variants by a method comprising:
taking, as input, a base scenario which is a known malware sample, along with a set of test cases or TTPs (Tactics, Techniques, and Procedures) that describe various aspects of the malware's behavior, wherein the test cases serve as reference points;
automatically modifying the malware by a method comprising:
identifying sub-techniques and procedures within the malware scenario or campaign; changing the sub-techniques or their procedures without changing the techniques to obtain the modified variants by keeping the core behavior of the malware unchanged; and,
running the test cases against each variant to validate the existence of the core behavior of the malware.

The method further comprises taking, as output, the modified variants, each representing a variation of the base scenario; and testing and comparing the risk associated with both, the base malware and the modified variant, against a pre-defined threshold of risk.

The test cases or TTPs of the malware are based on MITRE ATT&CK framework. The modification of the malware involves the brute force of all available TTPs and trying all possible attack paths to check which paths are able to achieve the pre-defined threshold of risk, with the restriction of changing only the sub-techniques or procedures, and wherein a sequence of TTPs are created providing with multiple TTP combinations, covering all available attack paths to identify the paths having higher risk than the defined threshold. The predefined threshold is user-defined and can be adjusted to meet specific malware modification objectives.

In another embodiment, the modification of the malware involves changes only in those attack paths or TTPs that have been blocked by a specified security control and checking all modified paths that are able to achieve the pre-defined threshold of risk, with the restriction of changing only the sub-techniques or procedures.

The system and method of the embodiment, generate a human-friendly report that provides a summary of the evaluations and associated risk levels for all the created attack paths, allowing users to make informed decisions regarding their security posture. The report is accessible through a user interface.

The system also records the interactions and behaviors of the malware variations with each security control, capturing high-impact attack paths against that specific security control. The recorded data is analyzed to identify high-impact attack paths for each security control, assessing the effectiveness of each security control based on the recorded behaviors.

Multiple variants of malware are uploaded on sandboxes and online threat repositories on daily basis, that's because every single malware campaign is changed or tweaked and there are created hundreds of different malware variants from base scenario to bypass detection from security controls. The methodology for Malware Evolution Assessment deals with this particular problem. It provides evolutions for base malware campaign in a way that the context of original malware campaign is not changed but rather introduces changes in the procedures of malware behavior at granular level.

Malware Evolution Assessment is a security assessment method designed to enhance cybersecurity testing by generating multiple variants of a malware scenario. This framework is focused on testing security controls and defenses against evolving threats, which is an essential aspect of modern cybersecurity. The methodology involves taking a base malware scenario or sample and applying various mutations, changes, or adaptations to it. These changes may include altering the procedures of malware without affecting the original malware behavior. By doing so, it creates a diverse set of malware variants that mimic real-world malware evolution. Once these variants are generated, they are likely tested against security controls, systems, or networks to evaluate how well those defenses can detect, mitigate, or prevent the evolving threats. This method may help organizations and security teams understand the effectiveness of their security measures in the face of dynamic and adaptive cyber threats. By continuously evolving and testing malware campaigns, the framework may provide valuable insights into the robustness of an organization's cybersecurity posture and help identify areas where improvements are needed. It also aids in the development and tuning of security tools to better adapt to emerging threats.

The invention may uncover patterns, trends, and commonalities in the behaviors, tactics, and techniques of the malware being tested. Security analysts may analyze the results to identify recurring patterns of adaptation and evolution within a specific malware family. This insight may allow them to develop a deeper understanding of the threat actor's strategies and objectives. Moreover, as the methodology generates multiple variants of a malware scenario and tests them against security controls, it can help analysts discern which changes are more likely to evade detection or mitigation. This information is invaluable in anticipating the directions in which threat actors may evolve their tactics, as well as the potential vulnerabilities and weaknesses that might be exploited. As a result, security analysts can proactively prepare and enhance their defenses based on this predictive analysis. This proactive stance may enable organizations to stay one step ahead of cyber adversaries and significantly strengthen their overall cybersecurity posture. The invention provides an ability to predict next or upcoming attack variants and empowers security analysts with actionable insights, allowing them to not only understand the past and current behavior of malware but also anticipate and prepare for future threats, ultimately enhancing their organization's cybersecurity resilience.

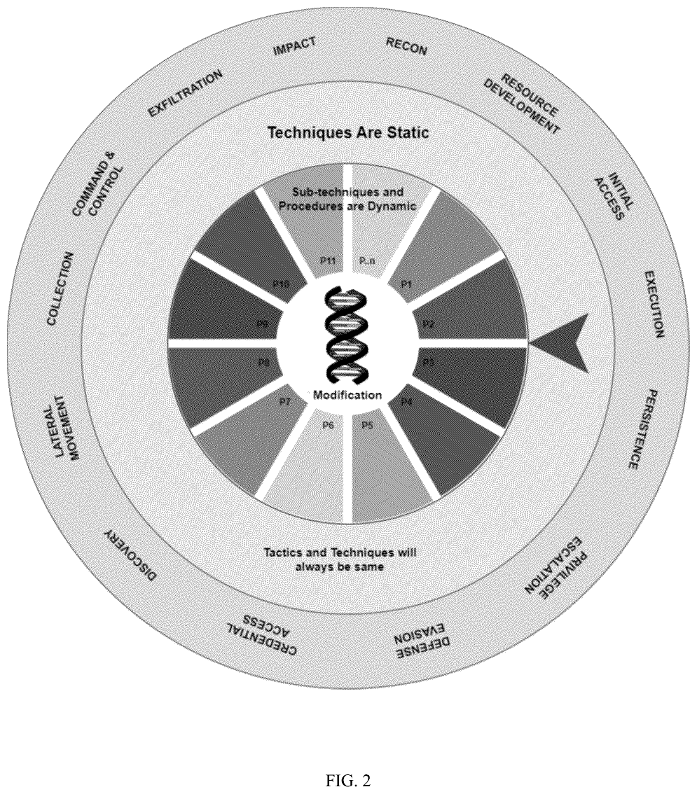

FIG. 2 shows the generic methodology of evolving malware without changing the actual behavior of malware. The purpose of this assessment is not to create custom malware but to evolve the original base malware scenario without changing its overall behavior. For example, if a campaign is using the tactic of defense evasion using the technique of process injection and sub-technique of portable executable injection then in the evolution process it would change the sub-technique or procedure from PE injection to be process hollowing or any other sub-technique which has higher risk of evading defenses. This restriction of changing only sub-technique and procedures randomly ensures that the original context of malware is kept alive.
Original malware: Defense Evasion→Process Injection→PE Injection
Modified malware: Defense Evasion→Process Injection→Process Hollowing

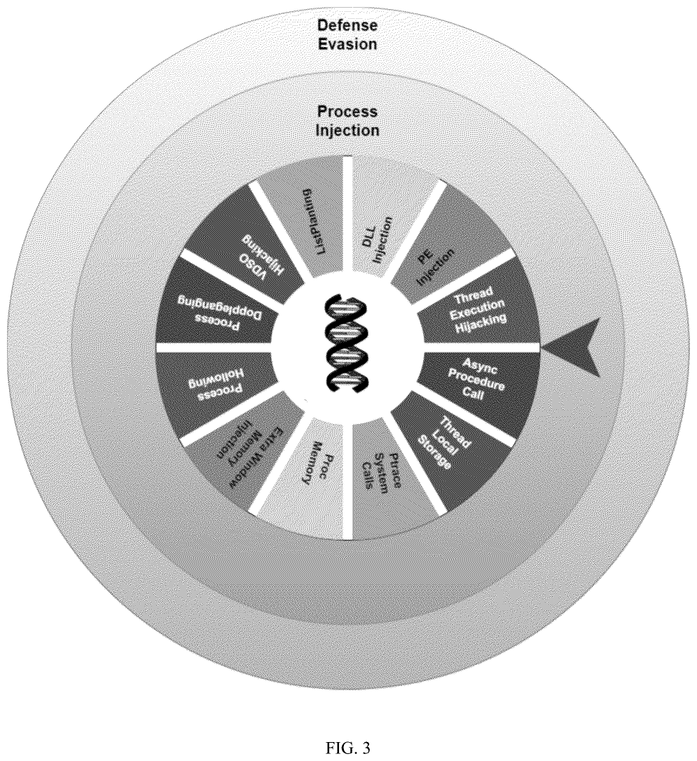

A single malware behavior is mapped on a single TTP and multiple TTPs together create a single malware campaign or a scenario. To alter malware behavior, sub-techniques, and procedures are changed to evolve the malware TTPs as explained in FIG. 3. The Malware Evolution Assessment methodology executes the whole malware campaign by dividing it into multiple behaviors which gives it complete control over modifying the input and output of each individual behavior. It also provides very useful insights to the user like which behaviors are detected by organization's security controls and which are undetectable. This detail of security assessment at such a granular level is what makes this possible to predict upcoming potential risky attack vectors against a specific organization.

### Malware Evolution:

An automated malware evolution platform is a sophisticated tool to be used in cybersecurity research and defense. This platform focuses on altering sub-techniques and procedures while keeping the tactics and techniques the same as a base malware campaign. Its primary purpose is to create variations of known malware samples without changing their core behavior, thereby assisting cybersecurity professionals, researchers, and organizations in enhancing their cyber defenses.

Input: The platform takes a base scenario, typically a known malware sample, as its input. Along with the base scenario, it requires a set of test cases or TTPs that describe various aspects of the malware's behavior, all based on MITRE ATT&CK framework. These test cases serve as reference points for evaluating various adaptations. The test cases are individual exploits each obtaining a single objective as mentioned by MITRE ATT&CK framework.

Modification Process: The automated malware modification process involves several key steps. Firstly, it identifies sub-techniques and procedures within the malware scenario or campaign. Sub-techniques are specific methods or steps used to achieve a broader technique. For example, a malware technique might be “Command and Control,” and sub-techniques could include DNS tunneling or HTTP communication. The platform then modifies these MITRE sub-techniques while keeping MITRE techniques the same. This could involve changing malware procedures like network protocols, or communication intervals.

Importantly, the platform ensures that the core behavior of the malware remains unchanged throughout the evolution process. For instance, if the original malware is designed to exfiltrate sensitive data to a remote server, the evolved versions will also perform data exfiltration but with variations in how they achieve it. After creating modified versions, the platform runs the test cases against each variant to validate that they still exhibit the expected behavior described in the test cases. This ensures that the modifications did not inadvertently alter the fundamental functionality of the malware.

The criteria for evolving these malware campaigns are of two types:
Deep Inspection: which brute force all available TTPs and try all possible attack paths to check which paths are able to achieve the defined threshold, with the restriction of changing only the sub-techniques and procedures.
Attack Survival: which only changes attack paths or TTPs that have been blocked by the specified security controls and check all modified paths that are able to achieve the defined threshold, with the restriction of changing only the sub-techniques and procedures.

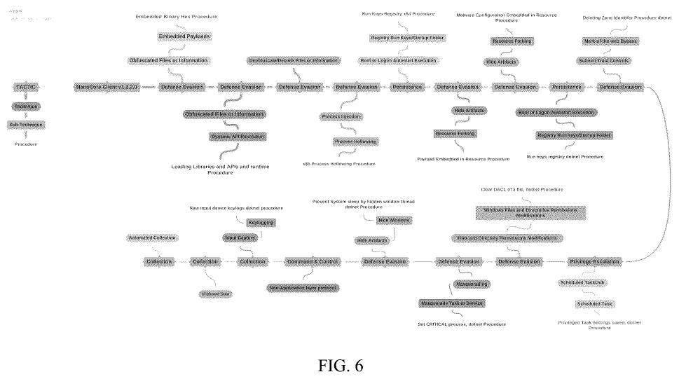

The base scenario of NanoCore RAT and all its TTPs that have been extracted into individual test cases. The TTPs of NanoCore RAT v1.2.2.0 that have been extracted by our reverse engineering team have been listed below, FIG. 6:
1. Defense Evasion→Obfuscated Files or Information→Embedded Payloads (embedded binary hex)
2. Defense Evasion→Obfuscated Files or Information→Dynamic API Resolution (Loading library and APIs at runtime)
3. Defense Evasion→Deobfuscate/Decode Files or Information (encrypted payload)
4. Defense Evasion→Process Injection→Process Hollowing (x86 process hollowing)
5. Persistence→Boot or Logon Autostart Execution→Registry Run Keys/Startup Folder (Run keys registry x64)
6. Defense Evasion→Hide Artifacts→Resource Forking (Payload embedded in resources)
7. Defense Evasion→Hide Artifacts→Resource Forking (Malware config embedded in resources)
8. Persistence→Boot or Logon Autostart Execution→Registry Run Keys/Startup Folder (Run keys registry dotnet)
9. Defense Evasion→Subvert Trust Controls→Mark-of-the-web Bypass (Delete zone identifier dotnet)
10. Privilege Escalation→Scheduled Task/Job→Scheduled Task (Privileged Task settings saved dotnet)
11. Defense Evasion→Files and Directory Permissions Modifications→Windows Files and Directory Permissions Modifications (Clear DACL dotnet)
12. Defense Evasion→Masquerading→Masquerade Task or Service (Set Critical Process dotnet)
13. Defense Evasion→Hide Artifacts→Hide Window (Prevent System sleep by hidden window thread dotnet)
14. Command and Control→Non-Application layer Protocol (TCP sockets dotnet)
15. Collection→Input Capture→Keylogging (Raw input device keylogs dotnet)
16. Collection→Clipboard Data (Clipboard data log dotnet)
17. Collection→Automated Collection (DnsCache table log dotnet)

The embodiments of the invention use Malware Evolution Engine, a software which takes a base malware scenario (sequence of TTPs) and apply modifications to that sequence by changing sub-techniques or procedures against the listed TTPs with both methods, the deep inspection method and the attack survival method. First, there are listed a few of the attack paths created by Malware Evolution Engine with risk score higher than defined threshold which is 70%.

### Deep Inspection Method:

Deep inspection method, brute force all available TTPs in an attack sequence that could be changed based on the restriction of sub-techniques and procedures. The malware evolution engine creates a sequence of TTPs and provides multiple TTP combinations covering all available attack paths and lists those paths that have higher risk than the defined threshold.

For example, if it is desired to see all available attack paths that have a higher risk than 70% of NanoCore RAT malware then deep inspection method is used which would test and list all available attack paths followed by NanoCore malware. These attack paths are, however, limited by the availability of TTPs in our threat library. If an attack has not been updated in our threat library, then we can't cover that specific attack path. This example lists a few of the evolved campaigns with modified attack paths or cyber-attack execution cycle.

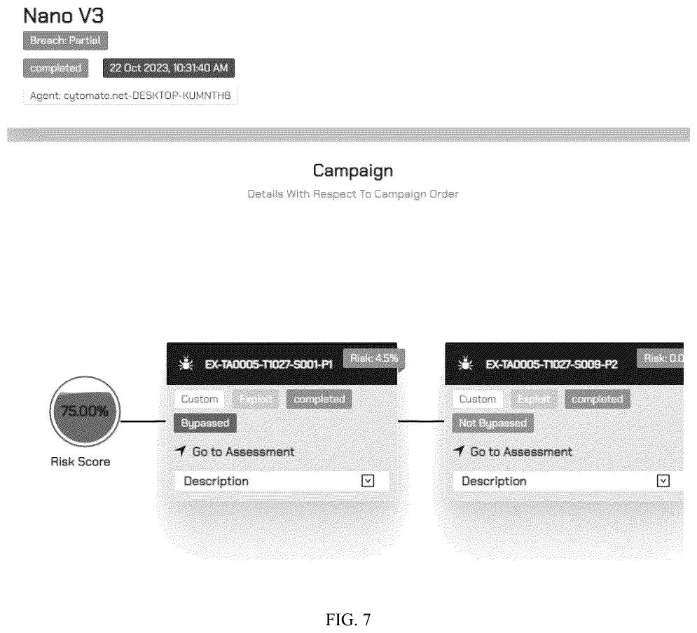

The first evolution created by our engine that has a risk higher than 70% has these TTPs in order (TTPs encased in curly brackets “{ }” with bold, italic and underlined text are showing the modified TTPs):
1. Defense Evasion→Obfuscated Files or Information→{Binary Padding (junk data added)}
2. Defense Evasion→Obfuscated Files or Information→{Embedded Payloads (obfuscated shellcode)}
3. Defense Evasion→Deobfuscate/Decode Files or Information (encrypted payload)
4. Defense Evasion→Process Injection→{Process Doppleganging (hasherzade poc)}
5. Persistence→Boot or Logon Autostart Execution→Registry Run Keys/Startup Folder {(Run keys registry dotnet)}
6. Defense Evasion→Hide Artifacts→{Hidden Files and Directories (attrib procedure)}
7. Defense Evasion→Hide Artifacts→{Hide Window (Prevent System sleep by hidden window thread dotnet)}
8. Persistence→Boot or Logon Autostart Execution→Registry Run Keys/Startup Folder {(Startup folder. Ink file)}
9. Defense Evasion→Subvert Trust Controls→Mark-of-the-web Bypass {(image malware iso)}
10. Privilege Escalation→Scheduled Task/Job→Scheduled Task (Privileged Task settings saved dotnet)
11. Defense Evasion→Files and Directory Permissions Modifications Windows Files and Directory Permissions Modifications {(icacls grant permissions)}
12. Defense Evasion→Masquerading→{Match Legitimate Name or Location (Legitimate Named malicious binaries)}
13. Defense Evasion→Hide Artifacts→{Resource Forking (Malware config embedded in resources)}
14. Command and Control→Non-Application layer Protocol (TCP sockets dotnet)
15. Collection→Input Capture→Keylogging (Raw input device keylogs dotnet)
16. Collection→Clipboard Data (Clipboard data log dotnet)
17. Collection→Automated Collection (DnsCache table log dotnet)
   The above listed points show evolved malware campaign that achieved overall 75% risk in the assessment. TTPs were changed from the original base malware scenario in a way that the flow of cyber-attack execution has not been changed. It is shown in a screenshot given in FIG. 7.

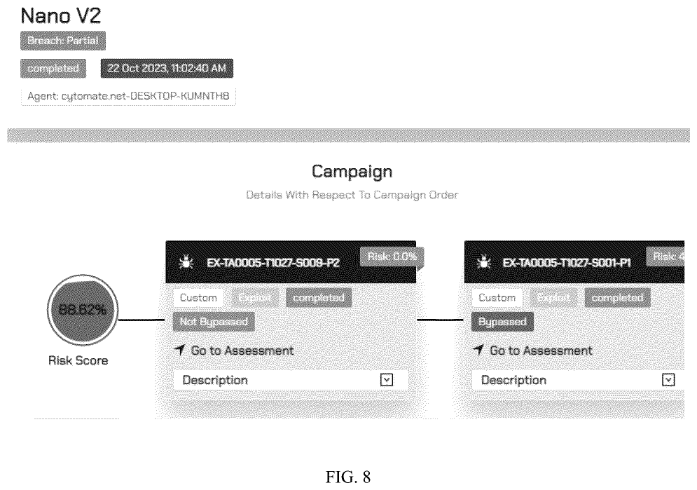

Another malware evolution created by our system has even higher risk score almost 88% is listed below (TTPs encased in curly brackets “{ }” with bold, italic and underlined text are showing the modified TTPs), FIG. 8:
1. Defense Evasion→Obfuscated Files or Information→{Embedded Payloads (obfuscated shellcode)}
2. Defense Evasion→Obfuscated Files or Information→{Binary Padding (junk data added)}
3. Defense Evasion→Deobfuscate/Decode Files or Information (encrypted payload)
4. Defense Evasion→Process Injection→{Portable Executable Injection (x86 PE injection)}
5. Persistence→Boot or Logon Autostart Execution→Registry Run Keys/Startup Folder {(Startup folder. Ink file)}
6. Defense Evasion→Hide Artifacts→Resource Forking {(Malware config embedded in resources)}
7. Defense Evasion→Hide Artifacts→Resource Forking {(Payload embedded in resources)}
8. Persistence→Boot or Logon Autostart Execution→Registry Run Keys/Startup Folder {(Run keys registry dotnet)}
9. Defense Evasion→Subvert Trust Controls→Mark-of-the-web Bypass {(image malware iso)}
10. Privilege Escalation→Scheduled Task/Job→Scheduled Task (Privileged Task settings saved dotnet)
11. Defense Evasion→Files and Directory Permissions Modifications→Windows Files and Directory Permissions Modifications {(icacls restrict permissions)}
12. Defense Evasion→Masquerading→{Rename System Utilities (launch renamed binary)}
13. Defense Evasion→Hide Artifacts→{Hidden Files and Directories (attrib procedure)}
14. Command and Control→Non-Application layer Protocol (TCP sockets dotnet)
15. Collection→Input Capture→Keylogging (Raw input device keylogs dotnet)
16. Collection→Clipboard Data (Clipboard data log dotnet)
17. Collection→Automated Collection (DnsCache table log dotnet)
   Now we have discovered another attack path, which has an even higher impact or risk score than the previous one. This procedure provides us with all possible attack paths by creating combinations from the threat library.

### Attack Survival Method:

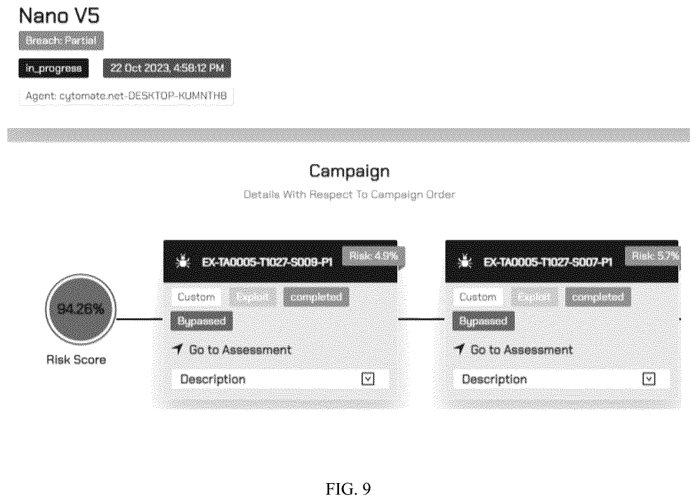

In the attack survival method, the malware is evolved in a way that we change or modify only those TTPs that have been blocked by the deployed security control of a base malware scenario. For example, we assess the base campaign and only 2 TTPs have been blocked out of 12 TTPs, so we will test all possible combinations by modifying or changing only those 2 TTPs to achieve a better result. The attack survival method provides more effective results, but it also decreases the number of possible combinations that could be tested. The attack survival method of evolving malware campaigns yields better results, like in the following example, we have found a cyber-attack path of NanoCore RAT that yields up to 94% of overall risk, FIG. 9.

The malware evolution created by attack survival method shows only a single TTP has been detected by security controls and our system replaced the detected TTP with its counterpart. It is listed below (TTPs encased in curly brackets “{ }” with bold, italic and underlined text are showing the modified TTPs):
1. Defense Evasion→Obfuscated Files or Information→Embedded Payloads (embedded binary hex)
2. Defense Evasion→Obfuscated Files or Information→Dynamic API Resolution (Loading library and APIs at runtime)
3. Defense Evasion→Deobfuscate/Decode Files or Information (encrypted payload)
4. Defense Evasion→Process Injection→{PE Injection (x64 PE Injection)}
5. Persistence→Boot or Logon Autostart Execution→Registry Run Keys/Startup Folder (Run keys registry x64)
6. Defense Evasion→Hide Artifacts→Resource Forking (Payload embedded in resources)
7. Defense Evasion→Hide Artifacts→Resource Forking (Malware config embedded in resources)
8. Persistence→Boot or Logon Autostart Execution→Registry Run Keys/Startup Folder (Run keys registry dotnet)
9. Defense Evasion→Subvert Trust Controls→Mark-of-the-web Bypass (Delete zone identifier dotnet)
10. Privilege Escalation→Scheduled Task/Job→Scheduled Task (Privileged Task settings saved dotnet)
11. Defense Evasion→Files and Directory Permissions Modifications→Windows Files and Directory Permissions Modifications (Clear DACL dotnet)
12. Defense Evasion→Masquerading→Masquerade Task or Service (Set Critical Process dotnet)
13. Defense Evasion→Hide Artifacts→Hide Window (Prevent System sleep by hidden window thread dotnet)
14. Command and Control→Non-Application layer Protocol (TCP sockets dotnet)
15. Collection→Input Capture→Keylogging (Raw input device keylogs dotnet)
16. Collection→Clipboard Data (Clipboard data log dotnet)
17. Collection→Automated Collection (DnsCache table log dotnet)

Using these combinations provided by malware evolution engine, we can find all the vulnerable paths in an organization's security posture and proactively create mitigation strategies against all high-risk attack paths.

Output: The output of the platform consists of multiple evolved malware campaigns, each representing a variation of the base scenario. Along with these samples, the platform provides documentation detailing the changes made to sub-techniques and procedures. Additionally, it includes the results of the test cases, indicating whether the evolution successfully retained the expected behavior.

### Benefits:

a) Allows security professionals to gain insights into potential attack vectors and evasion techniques used by adversaries.
b) Strengthens threat intelligence databases by providing diverse perspectives on known malware.
c) Helps organizations fine-tune security tools, such as intrusion detection systems and antivirus software, for more effective threat detection and mitigation.
d) Enables proactive adjustments to defense strategies by anticipating evolving attack paths.
e) Helps security teams understand how various sub-techniques and procedures impact the malware's behavior.
f) Supports the development of more robust defense strategies through in-depth analysis of evolved malware variants.

### Re-Evaluation:

The re-evaluation component of a malware testing strategy is a crucial step in comprehensively assessing the behavior and impact of malicious software. Initially, a malware sample is subjected to rigorous testing on a controlled system environment to understand its characteristics, capabilities, and potential harm. However, the threat landscape is dynamic, and malware often evolves rapidly to evade detection and mitigation measures. To address this challenge, after the malware has been tested, researchers may intentionally modify the malware, making subtle or significant changes to its code, structure, or behavior. This modified version is then reintroduced into the same system under the same conditions as the initial testing. This iterative process is essential to gauge the malware's adaptability and its ability to circumvent security measures. By re-evaluating the modified malware, security experts can identify vulnerabilities, assess the effectiveness of security solutions, and refine their defense strategies to stay ahead of evolving threats in the ever-changing world of cybersecurity.

### Risk Comparison:

Comparing the risk associated with both the base malware and its modified counterpart is a critical aspect of understanding the evolving threat landscape. After conducting thorough testing, security experts assess the impact of each version on the system. This assessment typically involves analyzing factors such as system compromise, data exfiltration, lateral movement within the network, and potential damage to critical assets. The impact is then quantified and compared for both the original and modified malware.

If the impact of the modified malware surpasses a predetermined threshold, it signifies a heightened level of risk. Such a scenario suggests that the malware's evolution has been successful otherwise the modification will be discarded. It shows that the evolved malware either successfully exploited a vulnerability or evaded security measures, rendering it more potent and dangerous. Additionally, if the impact exceeds the established threshold, it could signal a potential future attack vector that malware authors may explore in subsequent variants. Malicious actors often learn from other successful TTPs and adapt their tactics, accordingly, making it essential for security professionals to recognize and preemptively defend against emerging threat patterns. By identifying these high-impact evolutions, security teams can prioritize the development of countermeasures, updates, or patches to mitigate the risks associated with the evolving malware landscape and safeguard their systems effectively. This proactive approach helps organizations stay ahead of potential attacks and strengthens their overall cybersecurity posture.

What is claimed is:

1. A computer-implemented method, comprising:
automatically creating malware variants by a method comprising:
taking, as input, a base scenario which is a known malware sample, along with a set of test cases or TTPs (Tactics, Techniques, and Procedures) that describe various aspects of the malware's behavior, wherein the test cases serve as reference points;
automatically modifying the malware by a method comprising:
identifying sub-techniques and procedures within the malware scenario or campaign;
changing the sub-techniques or their procedures without changing the techniques to obtain the modified variants by keeping the core behavior of the malware unchanged; and,
running the test cases against each variant to validate the existence of the core behavior of the malware;
taking, as output, the modified variants, each representing a variation of the base scenario; and
testing and comparing the risk associated with both, the base malware and the modified variant, against a pre-defined threshold of risk.

2. The method of claim 1, wherein the test cases or TTPs of the malware are based on MITRE ATT&CK framework.

3. The method of claim 1, wherein the modification of the malware involves the brute force of all available TTPs and trying all possible attack paths to check which paths are able to achieve the pre-defined threshold of risk, with the restriction of changing only the sub-techniques or procedures, and wherein a sequence of TTPs are created providing with multiple TTP combinations, covering all available attack paths to identify the paths having higher risk than the defined threshold.

4. The method of claim 1, wherein the modification of the malware involves changes only in those attack paths or TTPs that have been blocked by a specified security control and checking all modified paths that are able to achieve the pre-defined threshold of risk, with the restriction of changing only the sub-techniques or procedures.

5. The method of claim 1, wherein the predefined threshold is user-defined and can be adjusted to meet specific malware modification objectives.

6. The method of claim 1, further comprising generating a human-friendly report that provides a summary of the evaluations and associated risk levels for all the created attack paths, allowing users to make informed decisions regarding their security posture.

7. The method of claim 6, wherein the report is accessible through a user interface.

8. A system comprising:
a computer server, configured to generate a plurality of combinations of TTPs;
a testing module, configured to evaluate each combination of TTPs against a pre-defined threshold to determine their effectiveness;
and a modification module, configured to adapt the TTP combinations based on the testing results until the predefined threshold is achieved;
where the system is configured to execute a method comprising:
automatically creating malware variants by a method comprising:
taking, as input, a base scenario which is a known malware sample, along with a set of test cases or TTPs (Tactics, Techniques, and Procedures) that describe various aspects of the malware's behavior, wherein the test cases serve as reference points;
automatically modifying the malware by a method comprising:
identifying sub-techniques and procedures within the malware scenario or campaign;
changing the sub-techniques or their procedures without changing the techniques to obtain the modified variants by keeping the core behavior of the malware unchanged; and,
running the test cases against each variant to validate the existence of the core behavior of the malware;
taking, as output, the modified variants, each representing a variation of the base scenario; and
testing and comparing the risk associated with both, the base malware and the modified variant, against a pre-defined threshold of risk.

9. The system of claim 8, wherein the test cases or TTPs of the malware are based on MITRE ATT&CK framework.

10. The system of claim 8, wherein the modification of the malware involves the brute force of all available TTPs and trying all possible attack paths to check which paths are able to achieve the pre-defined threshold of risk, with the restriction of changing only the sub-techniques or procedures, and wherein a sequence of TTPs are created providing with multiple TTP combinations, covering all available attack paths to identify the paths having higher risk than the defined threshold.

11. The system of claim 8, wherein the modification of the malware involves changes only in those attack paths or TTPs that have been blocked by a specified security control and checking all modified paths that are able to achieve the pre-defined threshold of risk, with the restriction of changing only the sub-techniques or procedures.

12. The system of claim 8, wherein the predefined threshold is user-defined and can be adjusted to meet specific malware modification objectives.

13. The system of claim 8, further comprising generating a human-friendly report that provides a summary of the evaluations and associated risk levels for all the created attack paths, allowing users to make informed decisions regarding their security posture.

14. The system of claim 13, wherein the report is accessible through a user interface.

15. The system of claim 8, wherein the system records the interactions and behaviors of the malware variations with each security control, capturing high-impact attack paths against that specific security control.

16. The system of claim 15, wherein the recorded data is analyzed to identify high-impact attack paths for each security control, assessing the effectiveness of each security control based on the recorded behaviors.
